(19) United States
(12) Patent Application Publication
(10) Pub. No.: US 2007/0265768 A1
(43) Pub. Date: Nov. 15, 2007

(54) Dash mounted or handheld audible-visual road advisory-information system device

(76) Inventor: Robert Brown JR., Warner Robins, GA (US)

Correspondence Address: Robert Brown Jr., 1613 Sweetwater Dr., Warner Robins, GA, 31088, US

(21) Appl. No.: 11/397,142

(22) Filed: May 12, 2006

(51) Int. Cl. G01C 21/00

(52) U.S. Cl. 701/200; 701/211

(57) ABSTRACT

A dash mounted or handheld audible-visual road advisory-information system device, for improving driver awareness and highway safety, that outputs amber alert warning notices and highway advisory information, and a summary of businesses and contact number, operating hours, and detailed summaries of business services, special sales and advertisements which are found-located on a highway and at a highway exit, in electronic voice through speaker and in text on display screen mounted either on the dash of a vehicle, built inside a vehicle radio, or portable-mobile handheld device.

### TECHNICAL FIELD

This invention relates to static highway amber alert warning signs and automobile road navigation systems. More particularly, relates to a road advisory-information system device which outputs audible-visual amber alert warning notices and a summary of businesses with location, contact number, operating hours, and detailed summaries of business services, special sales and advertisements which are found-located on a highway and at a highway exit, in electronic voice and in text on display screen either mounted on the dash of a vehicle, built inside a vehicle radio, or portable-mobile handheld device.

### BACKGROUND OF THE INVENTION

In recent decades, police, Department Of Transportation, and emergency management personnel have positioned a limited number of static amber alert warning signs along highways to manage traffic and to provide amber alert warnings and highway information notices to drivers and motorists.

Today's motorists will require emergency road service assistance and the convenience of knowing what businesses, business services, special sales and advertisements are available at an exit in the vicinity of a local area while enroute prior to arriving at an exit while leisurely driving, shopping trips-mall hopping, or touring the country.

Sometimes life and road conditions have dictated a need for a better highway amber alert warning-advisory and information system to preclude traffic safety deficiency conditions while driving daily and routinely, and as well as while traveling during an emergency evacuation due to threatening hurricanes and bad weather of recent months and years, such as the following:

a) Today's motorists are hampered-handicapped by not being able to completely read the information on the static highway amber alert warning signs, due to current signs static overhead position, limited number of strategic sign locations, blurred weather conditions impacting vision, and position of vehicle and proximity to moving traffic in relation to speed of travel.

b) Currently, a motorist is more endangered and at greater risk from not being able to prevent, reduce and avoid an accident(s)/potential accident(s) and road safety hazard when attention and eyes are focused away from the road, due to an attempt to read static overhead amber warning signs while simultaneously driving and driving during bad weather conditions.

c) A motorist is denied reception of audible amber alert warning notices, fingertip access of advance information and knowledge of a business location, contact number, hours of operation, services, special sales and advertisements that are found-located at an exit while enroute or in advance of traveling, due to existing configuration of static overhead amber alert warning signs.

The present invention claimed herein will overcome the above situations, limitations and disadvantages for a motorist, and can be placed in any vehicle and taken out of one vehicle and placed in another vehicle for instant use.

### BRIEF SUMMARY OF THE INVENTION

In view of the above, the present invention is presented to accomplish multiple objectives and advantages, including successfully providing solutions, such as the following:

It is an advantage and object of the present invention to improve highway safety by providing a safe dash mounted or handheld portable-mobile device and method for communicating, transporting and receiving amber alert warning notices and advisory information, which outputs an electronic voice through speakers for listening and on display screen to read and view, for allowing pre-trip planning and last minute adjustments in taking-making alternative routes to avoid travel delays while enroute, thereon.

It is another advantage and object of the present invention to provide a summary of businesses and contact number, hours of operation, and business services, special sales and advertisements which are found-located at a highway exit, for allowing advance knowledge of a local area-vicinity, convenience, and awareness while enroute, thereon.

It is still another advantage and object of the present invention to provide traffic safety advisories and highway information notices on the dash of a vehicle, for allowing a driver's eyes and attention to remain focused on the highway for safety reasons versus drivers having to look away and up to read a static overhead sign, thus eliminating or reducing real or potential accidents and a highway safety hazard, thereon.

It is a further advantage and object of the present invention to provide an audible-portable amber alert warning system device which can be used in any vehicle, that is mounted on the dash of a vehicle or handheld-portable, thereon.

It is yet another advantage and object of the present invention to output amber alert warnings, highway advisories and information notices in electronic voice, for allowing audible voice sound to compliment display screen for reading and viewing for communicating amber alert warning and advisory information notices safer, and for providing a dual-use transport method-delivery system mounted on the dash, thereon.

### DESCRIPTION OF THE SEVERAL VIEWS OF THE DRAWING(S)

The invention is herein described, by way of example only, with reference to the accompanying drawings, wherein:

FIG. 1 illustrates system device embodiment for allowing mounting on a vehicle dash or handheld for portability-mobility, thereon.

FIG. 2 illustrates system device manual controls, display screen, speaker, and power cord, thereon.

FIG. 3 illustrates system device front view, thereon.

FIG. 4 illustrates system device parts breakdown, thereon.

FIG. 5 illustrates system device rear view having battery compartment for allowing battery storage for portable-mobile handheld use, thereon.

FIG. 6 illustrates system device fit/use on dash, thereon.

FIG. 7 illustrated system device remote control device for allowing remote input and retrieval of information, thereon.

### DETAILED DESCRIPTION OF THE INVENTION

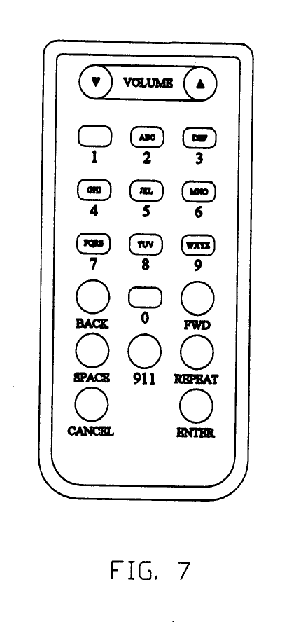

Referring to the drawings in greater detail, the system device 1 embodiment will typically comprise of embedded sensor 9 and remote control device FIG. 7, for allowing remote control device input of highway number to retrieve amber alerts while in route to avoid a delay/take alternate route for a particular area or highway, and input of highway exit number to retrieve advance summary of businesses with contact number, hours of operation, and a business services and special sales and advertisements found-located at a specific highway exit, for allowing additional knowledge of vicinity, convenience, display screen 11 for allowing reading and viewing text, speaker 2 for allowing voice output, battery box 18 battery compartment 14 for allowing portability-mobility, A/C-D/C power cord 16 and power cord adapter plug 17 for allowing recharging, antennae 12 wire 3 for allowing central hub-information center transmitter signal reception, synthesizer, converter, computer, or processor (CPU) 4 CPU fan 5 and circuit card assembly 6 for allowing received data signals from central hub-information center to process as output in electronic voice on speaker 2—outputting amber alert notices and a business name with contact number, location, services and sales found-located at an exit in electronic voice to hear and on display screen 11 for viewing and reading, manual controls 10 for allowing manual input of highway number and highway exit number, large machine screws 8 for allowing securing circuit card assembly 6, small machine screws 7 for allowing securing speaker 2 to housing, wire connector 13 for allowing attachments securing to circuit card assembly 6 and mounting bracket 15 for allowing dash mounting, attached thereon. System device 1 amber alert notices pre-empts business information queries.

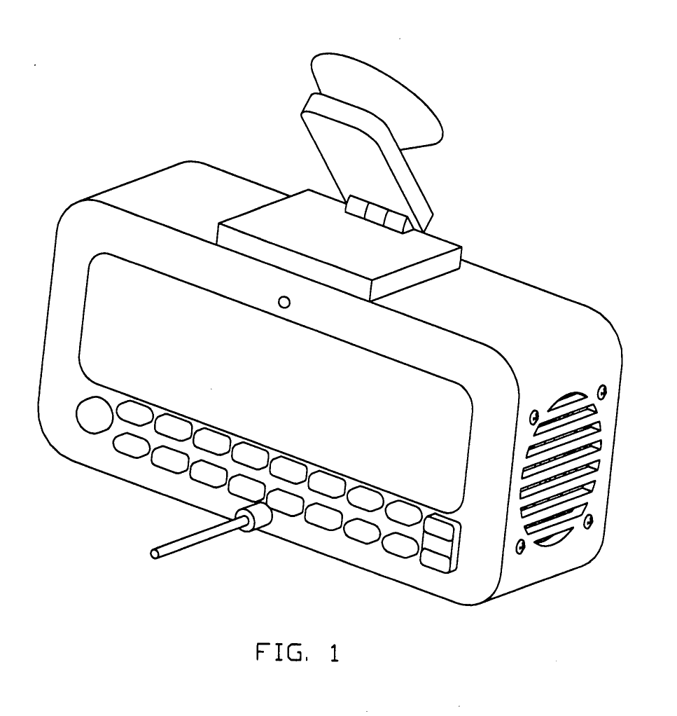

FIG. 1 illustrates system device 1 embodiment for allowing dash mounting or handheld use, attached thereon.

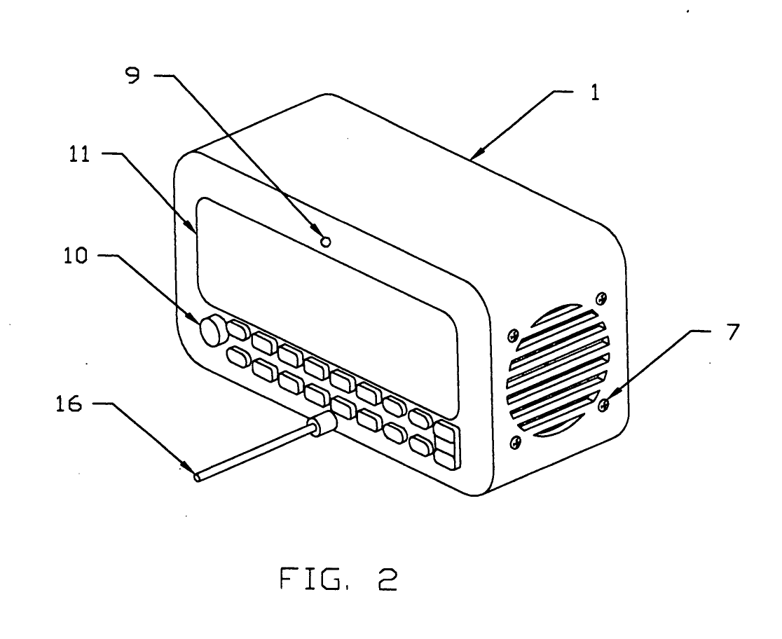

FIG. 2 illustrates system device 1 manual controls 10 for allowing manual text composition and entry and retrieval, attached thereon.

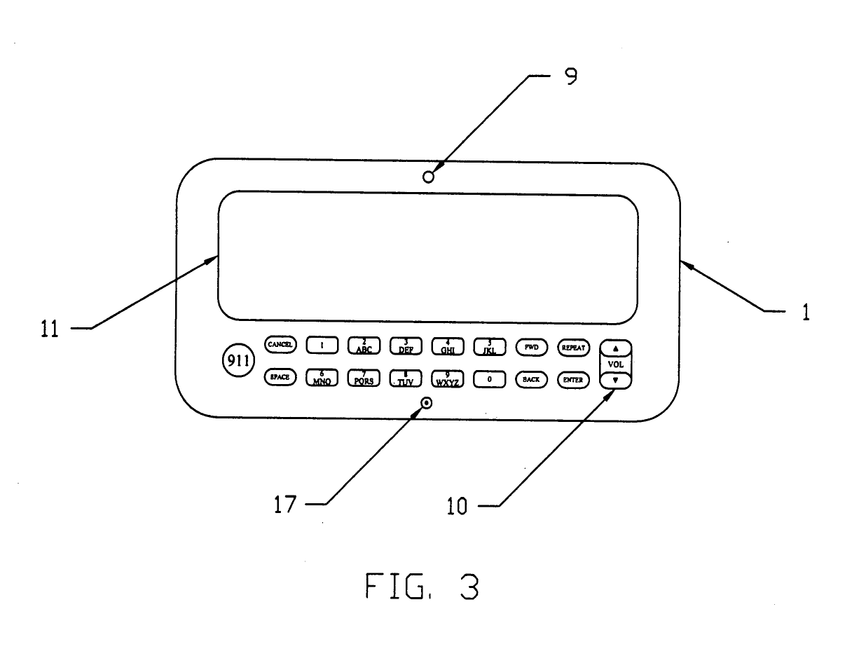

FIG. 3 illustrates system device 1 front view having manual controls 10 remote control device sensor 9 and display screen 11 for allowing text reading and viewing, attached thereon.

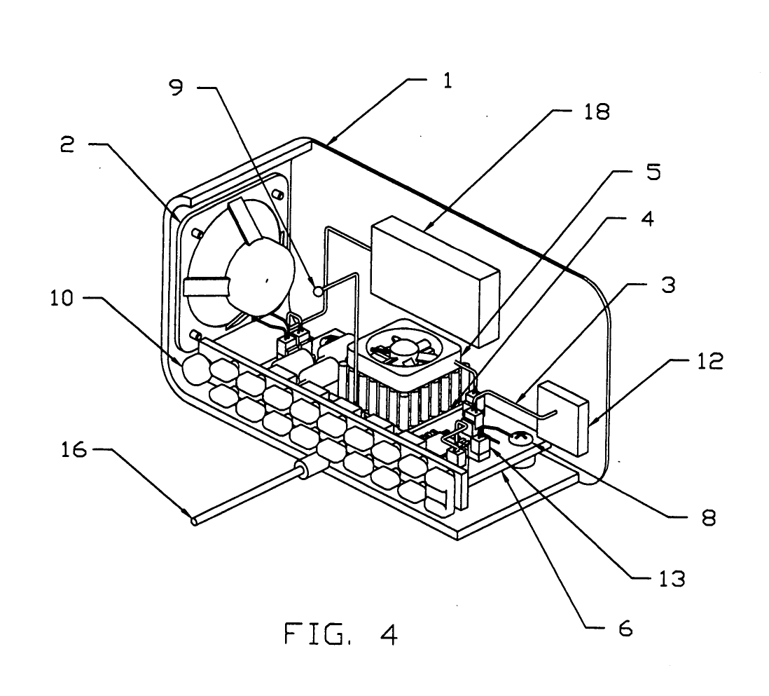

FIG. 4 illustrates system device 1 parts breakdown as referenced in paragraph attached thereon.

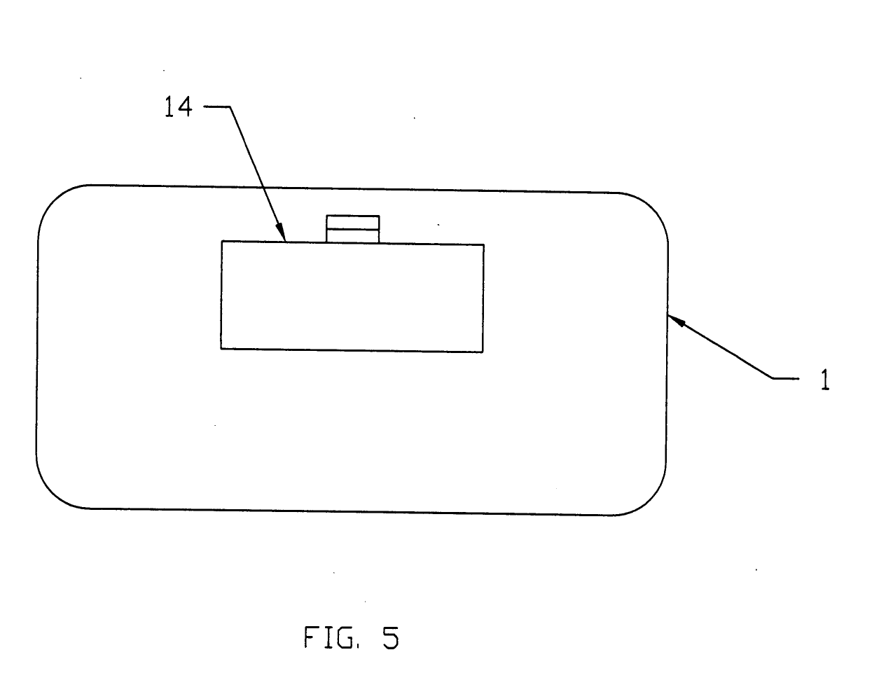

FIG. 5 illustrates system device 1 rear view having battery compartment 14 for allowing battery storage for allowing mobile and portable handheld use, attached thereon.

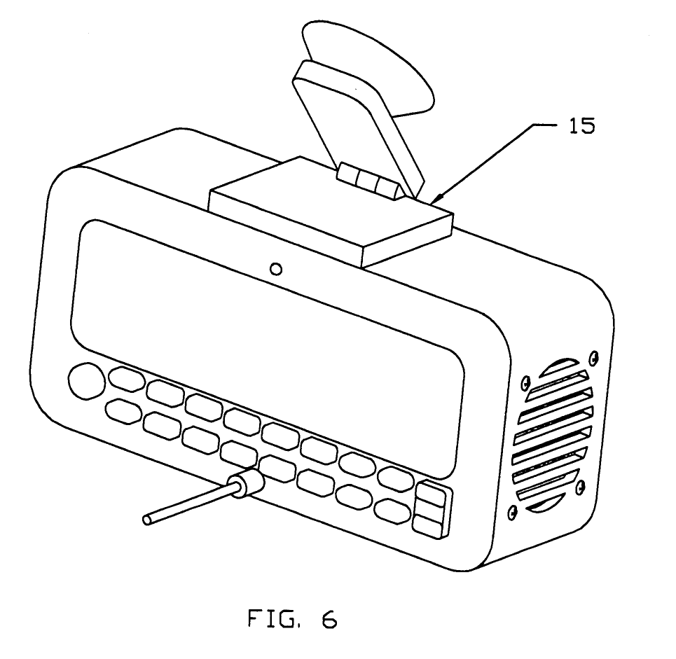

FIG. 6 illustrates system device 1 bracket for allowing dash mounting or handheld portability-mobility, attached thereon.

FIG. 7 illustrates system device 1 remote control device FIG. 7 for allowing retrieval of amber alert warnings posted on a particular highway route and information of businesses found-located at a specific exit, and for input of highway and exit number thereon.

I claim:

1. A dash mounted or handheld audible-visual road advisory-information system device with remote control device, that outputs amber alert warning notices and a summary of businesses with contact number, hours of operation, and detailed summaries of business services, special sales and advertisements which are found-located on a highway and at a highway exit, in electronic voice through speaker and on display screen mounted either on the dash of a vehicle, built inside a vehicle radio, or portable-mobile handheld device, comprising:
a) A road advisory-information system device with a remote control device;
b) said road advisory-information system device having audible voice output and display screen attached thereon;
c) said road advisory-information system device having speaker, attached thereon.
d) said road advisory-information system device having battery and A/C-D/C power sources attached thereon.
e) said road advisory-information system device having CPU-synthesizer, converter, computer, or processor attached therein.
f) said road advisory-information system device having manual button controls attached thereon.
g) said road advisory-information system device having antennae, attached therein.
h) said road advisory-information system device having embedded remote control device sensor, attached thereon.
